(19) United States
(12) Patent Application Publication
(10) Pub. No.: US 2011/0075834 A1
(43) Pub. Date: Mar. 31, 2011

(54) CROSSTALK CONTROL USING DELAYED POST-COMPENSATION IN A MULTI-CHANNEL COMMUNICATION SYSTEM

(76) Inventors: Alexei E. Ashikhmin, Morristown, NJ (US); Adriaan J. De Lind Van Wijngaarden, New Providence, NJ (US); Michael L.F. Peeters, Lint (BE); Philip Alfred Whiting, New Providence, NJ (US)

(21) Appl. No.: 12/570,093

(22) Filed: Sep. 30, 2009

(51) Int. Cl. H04B 1/12; H04M 1/74

(52) U.S. Cl. 379/417; 375/346; 375/285

(57) ABSTRACT

An access node of a communication system receives signals over respective first and second channels of the system, processes the signal received over the second channel and an initialization signal associated with the first channel to obtain estimated crosstalk coefficients characterizing crosstalk from the first channel into the second channel, introduces respective predetermined delays into the respective signals received over the first and second channels, and utilizes the estimated crosstalk coefficients to adjust the signal received over the second channel as delayed by the corresponding predetermined delay in order to compensate for the crosstalk from the first channel into the second channel. The first and second channels may comprise respective joining and active subscriber lines of a DSL system.

### FIELD OF THE INVENTION

The present invention relates generally to multi-channel communication systems, and more particularly to techniques for controlling crosstalk between communication channels in such systems.

### BACKGROUND OF THE INVENTION

Multi-channel communication systems are often susceptible to crosstalk between the various channels, also referred to as inter-channel crosstalk. For example, digital subscriber line (DSL) broadband access systems typically employ discrete multi-tone (DMT) modulation over twisted-pair copper wires. One of the major impairments in such systems is crosstalk between multiple subscriber lines within the same binder or across binders. Thus, a transmission on one subscriber line may be detected on other subscriber lines, leading to interference that can degrade the throughput performance of the system. More generally, a given “victim” channel may experience crosstalk from multiple “disturber” channels, again leading to undesirable interference.

A wide variety of crosstalk mitigation techniques have been developed. For example, in some DSL systems, a precoder is used to achieve crosstalk cancellation for downstream communications between a central office (CO) and customer premises equipment (CPE). It is also possible to implement crosstalk control for upstream communications from the CPE to the CO, using so-called post-compensation techniques. These and other crosstalk mitigation techniques typically require estimation of crosstalk coefficients that characterize the interaction between the various channels.

Such crosstalk coefficient estimates are commonly utilized in situations in which it is necessary to “join” an additional line to a group of active lines in a DSL system. For example, it may become necessary to activate one or more inactive lines in a synchronization group that already includes multiple active lines.

An important challenge is to protect the active lines in the system when the crosstalk coefficient estimates are not yet available. This situation can arise, for example, when a previously inactive CPE begins transmitting initialization signals used to estimate crosstalk coefficients for post-compensation of upstream communications. The signals sent from the joining CPE can be used to estimate the crosstalk coefficients, but as long as the coefficients are not yet available, the active lines may be affected by excessive crosstalk interference and may potentially be dropped. The challenge is to estimate upstream crosstalk coefficients of a joining line in such a way that negligible interference is caused to already active lines.

One possible approach to this problem is to design modified initialization signals that do not disturb active lines. However, this approach will generally not work for systems that are already deployed, also referred to as “legacy” systems, since the CPE would need to be upgraded to support the modified initialization signals. One could instead simply accept temporary interference and the risk that lines can be dropped. As a pre-emptive measure, the margins on the active lines can be increased to reduce the probability that a joining line causes active lines to be dropped. Another technique proposed for legacy systems is to gradually ramp up the power spectral density (PSD) of the joining line by terminating the start-up phase repeatedly. See, for example, F. Sjöberg et al., “G. Vector: Support for Upstream FEXT Cancellation,” ITU-T SG15/Q4 Contribution CS-021, April 2008. This technique, however, results in a longer initialization time, and the performance of the active lines in the system is still adversely affected when the joining line is in the start-up phase.

### SUMMARY OF THE INVENTION

The present invention in one or more illustrative embodiments provides an improved crosstalk control approach referred to herein as delayed post-compensation, which advantageously alleviates the adverse impact of a joining line on one or more active lines by allowing initial crosstalk coefficient estimates to be obtained and utilized in a particularly quick and efficient manner. The delayed post-compensation approach is also beneficial in other situations involving sudden line changes.

In accordance with one aspect of the invention, an access node of a communication system comprises first and second receivers for receiving signals over respective first and second channels of the system, a crosstalk estimation module having inputs coupled to respective outputs of the first and second receivers, first and second buffers having inputs coupled to the respective outputs of the first and second receivers, and a crosstalk control module having inputs coupled to respective outputs of the first and second buffers and an additional input adapted to receive estimated crosstalk coefficients from the crosstalk estimation module. The crosstalk estimation module processes the signal received over the second channel and an initialization signal associated with the first channel to obtain the estimated crosstalk coefficients characterizing crosstalk from the first channel into the second channel. The first and second buffers are configured to introduce respective predetermined delays into the respective signals received over the first and second channels. The crosstalk control module utilizes the estimated crosstalk coefficients to adjust the signal received over the second channel as delayed by the second buffer in order to compensate for the crosstalk from the first channel into the second channel. The access node may comprise, for example, at least a portion of at least one CO of a DSL communication system.

In an illustrative embodiment, the first and second channels comprise respective joining and active subscriber lines of the DSL system, with each such subscriber line comprising a plurality of tones. The crosstalk estimation module may generate at least one of the estimated crosstalk coefficients as:

ĝ=(x^{†}y)/∥x∥²

where x=x₁ x₂ . . . xₙ denotes the initialization signal for a given tone of the first subscriber line, y=y₁ y₂ . . . yₙ denotes the signal received for the given tone of the second subscriber line, and n denotes a number of consecutive symbols used to transmit the signals.

As another example, the crosstalk estimation module may generate at least one of the estimated crosstalk coefficients as:

ĝ=(y_{sync}−a_{sync})/∥x_{sync}∥²,

where

y_{sync}=(yⱼ_{₁}, . . . ,yⱼ_{ₘ}),a_{sync}=(aⱼ_{₁}, . . . ,aⱼ_{ₘ}),x_{sync}=(xⱼ_{₁}, . . . , xⱼ_{ₘ}),

and where a_{sync}=(aⱼ_{₁}, . . . ,aⱼ_{ₘ}) denotes m synchronization symbols transmitted at respective instances j₁, . . . , jₘ for a given tone of the second subscriber line, y_{sync}=(yⱼ_{₁}, . . . ,yⱼ_{ₘ}) denotes the signal received for the given tone of second subscriber line for the m instances, and x_{sync}=(xⱼ_{₁}, . . . , xⱼ_{ₘ}) denotes the initialization signal for the given tone of the first subscriber line for the m instances.

Also, combinations of these and other techniques may be used to generate estimated coefficients. For example, the crosstalk estimation module may generate at least one of the estimated crosstalk coefficients as a combination of at least first and second different estimates of the coefficient, in which the first and second different estimates are weighted with their respective estimated precisions.

The disclosed techniques provide significant advantages over conventional approaches. For example, the crosstalk estimation module in the illustrative embodiments can quickly determine initial estimates of the crosstalk coefficients such that the initial estimates can be used to at least partially cancel the effects of crosstalk. This allows lines to join without significantly increasing the risk of line dropping, while retaining the advantages of post-compensation. As indicated above, the disclosed techniques can be applied in other situations where there is a sudden change in one or more lines, e.g., a disorderly leaving event, and in such situations also advantageously avoid significant rate loss for the active line or lines. Thus, the disclosed techniques provide a general mechanism for mitigating the crosstalk effects of sudden line changes.

These and other features and advantages of the present invention will become more apparent from the accompanying drawings and the following detailed description.

### BRIEF DESCRIPTION OF THE DRAWINGS

FIG. 1 is a block diagram of a multi-channel communication system in an illustrative embodiment of the invention.

FIG. 2 illustrates crosstalk between a joining line and multiple active lines in an illustrative embodiment of the invention.

FIG. 3 shows a more detailed view of one possible implementation of a portion of the FIG. 1 system.

### DETAILED DESCRIPTION OF THE INVENTION

The present invention will be illustrated herein in conjunction with exemplary communication systems and associated techniques for post-compensation or other types of crosstalk control in such systems. The crosstalk control may be applied in conjunction with joining subscriber lines or other communication channels to a group of active channels in such systems, tracking changes in crosstalk coefficients over time, or in other line management applications. It should be understood, however, that the invention is not limited to use with the particular types of communication systems and crosstalk control applications disclosed. The invention can be implemented in a wide variety of other communication systems, and in numerous alternative crosstalk control applications. For example, although illustrated in the context of DSL systems based on DMT modulation, the disclosed techniques can be adapted in a straightforward manner to a variety of other types of wired or wireless communication systems, including cellular systems, multiple-input multiple-output (MIMO) systems, Wi-Fi or WiMax systems, etc. The techniques are thus applicable to other types of orthogonal frequency division multiplexing (OFDM) systems outside of the DSL context.

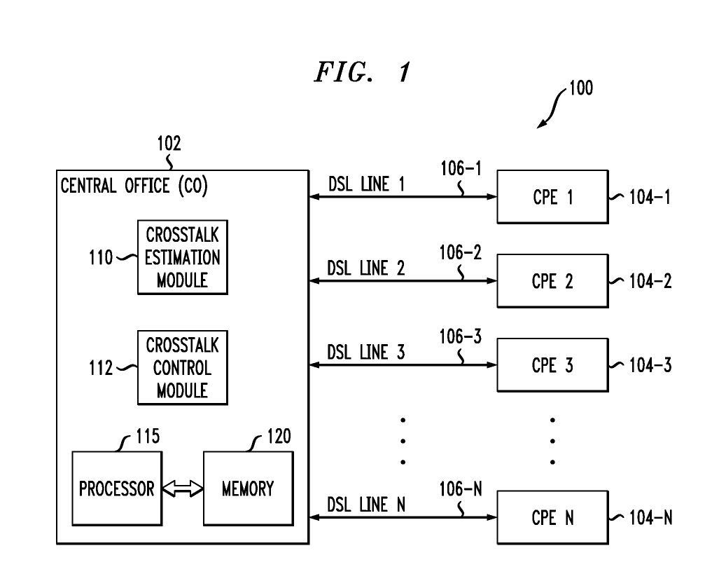

FIG. 1 shows a communication system 100 comprising a central office (CO) 102 and customer premises equipment (CPE) 104. The CPE 104 more particularly comprises N distinct CPE elements that are individually denoted CPE 1, CPE 2, . . . CPE N, and are further identified by respective reference numerals 104-1, 104-2, . . . 104-N as shown. A given CPE element may comprise, by way of example, a modem, a computer, or other type of communication device, or combinations of such devices. The CO 102 is coupled to these CPE elements via respective subscriber lines denoted Line 1, Line 2, . . . Line N, each of which may comprise, for example, a twisted-pair copper wire connection. These lines are further identified by respective reference numerals 106-1, 106-2, . . . 106-N.

In an illustrative embodiment, fewer than all of the N lines 106-1 through 106-N are initially active lines, and at least one of the N lines is a “joining line” that is to be activated and joined to an existing group of active lines. The initially active lines are an example of what is referred to herein as a “group” of active lines. Such a group may be, for example, a synchronization group, which may also be referred to as a precoding group, or any other type of grouping of active lines.

Communications between the CO 102 and the CPE 104 include both downstream and upstream communications for each of the active lines. The downstream direction refers to the direction from CO to CPE, and the upstream direction is the direction from CPE to CO. Although not explicitly shown in FIG. 1, it is assumed without limitation that there is associated with each of the subscriber lines of system 100 a CO transmitter and a CPE receiver for use in communicating in the downstream direction, and a CPE transmitter and a CO receiver for use in communicating in the upstream direction. The corresponding transmitter and receiver circuitry can be implemented in the CO and CPE using well-known conventional techniques, and such techniques will not be described in detail herein.

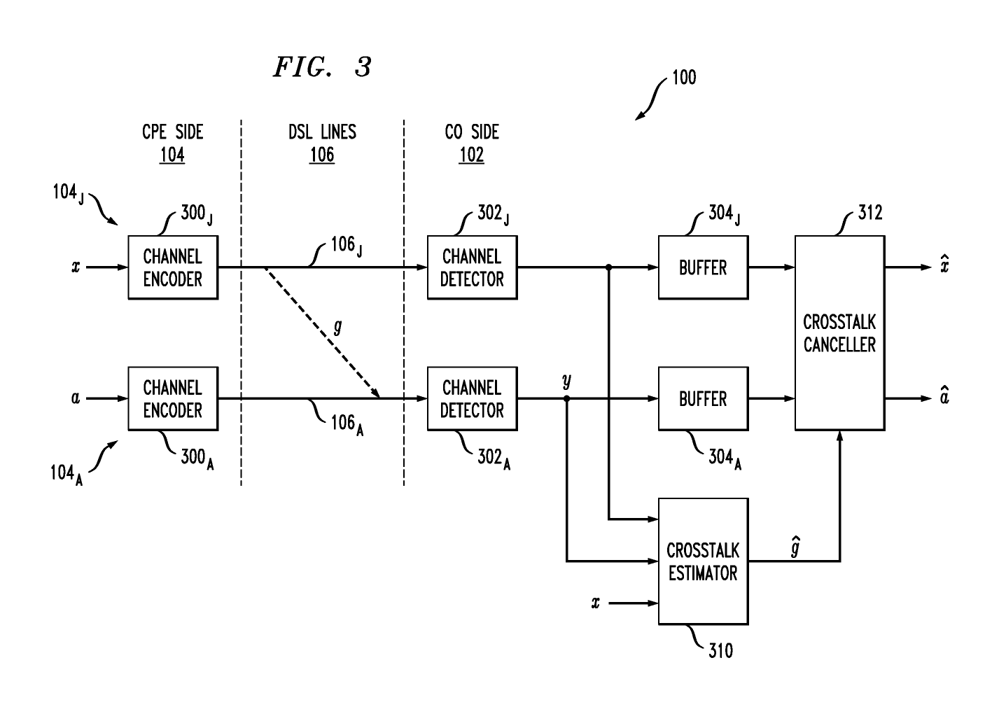

The CO 102 in the present embodiment comprises a crosstalk estimation module 110 and a crosstalk control module 112. The CO utilizes the crosstalk estimation module to obtain crosstalk estimates for respective ones of at least a subset of the lines 106. Such estimates are typically in the form of estimated crosstalk coefficients. The crosstalk control module 112 is used to mitigate, suppress or otherwise control crosstalk between at least a subset of the lines 106 based on the crosstalk estimates. For example, the crosstalk control module may be utilized to provide post-compensation of upstream signals transmitted from the CPE to the CO. Such post-compensation is implemented using a crosstalk canceller, an example of which will be described in conjunction with FIG. 3.

The crosstalk estimate generator 110 may incorporate denoising functionality for generating denoised crosstalk estimates. Examples of crosstalk estimate denoising techniques suitable for use with embodiments of the invention are described in U.S. patent application Ser. No. 12/352,896, filed Jan. 13, 2009 and entitled “Power Control Using Denoised Crosstalk Estimates in a Multi-Channel Communication System,” which is commonly assigned herewith and incorporated by reference herein. It is to be appreciated, however, that the present invention does not require the use of any particular denoising techniques. Illustrative embodiments to be described herein may incorporate denoising functionality using frequency filters as part of a channel coefficient estimation process.

The CO 102 may also or alternatively be configured to implement a technique for channel estimation using linear-model interpolation. Examples of such techniques are disclosed in U.S. patent application Ser. No. 12/493,328, filed Jun. 29, 2009 and entitled “Crosstalk Estimation and Power Setting Based on Interpolation in a Multi-Channel Communication System,” and U.S. patent application Ser. No. 11/934,347, filed Nov. 2, 2007 and entitled “Interpolation Method and Apparatus for Increasing Efficiency of Crosstalk Estimation,” both of which are commonly assigned herewith and incorporated by reference herein. As a simple example, crosstalk coefficients across a small group of consecutive tones might be taken to have equal value with negligible error. In this case a more accurate estimate is obtained by taking the average of the estimates over the group of tones.

The CO 102 further comprises a processor 115 coupled to a memory 120. The memory may be used to store one or more software programs that are executed by the processor to implement the functionality described herein. For example, functionality associated with crosstalk estimation module 110 and crosstalk control module 112 may be implemented at least in part in the form of such software programs. The memory is an example of what is more generally referred to herein as a computer-readable storage medium that stores executable program code. Other examples of computer-readable storage media may include disks or other types of magnetic or optical media.

The CO 102 or a portion thereof may be viewed as an example of what is more generally referred to herein as an “access node” of a communication system. A single access node may, but need not, comprise multiple COs or portions of one or more COs, or a single CO may comprise multiple access nodes. For example, one type of access node is a DSL access multiplexer (DSLAM). Thus, the term “access node” as used herein is intended to be broadly construed so as to encompass, for example, a particular element within a CO, such as a DSLAM, or the CO itself, as well as other types of access point elements in systems that do not include a CO.

In the illustrative embodiment of FIG. 1 the lines 106 are all associated with the same CO 102 which may comprise a single access node. However, in other embodiments, these lines may be distributed across multiple access nodes. Different ones of such multiple access nodes may be from different vendors. For example, it is well known that in conventional systems, several access nodes of distinct vendors can be connected to the same bundle of DSL lines. Under these and other conditions, the various access nodes may have to interact with one another in order to achieve optimal interference cancellation.

The terms “customer premises equipment” or CPE should be construed generally as including other types of user equipment in the context of non-DSL systems. Such CPE or other user equipment may be more generally referred to herein as terminal units.

Each of the CPE 104 may be configurable into multiple modes of operation responsive to control signals supplied by the CO 102 over control signal paths, as described in U.S. patent application Ser. No. 12/060,653, filed Apr. 1, 2008 and entitled “Fast Seamless Joining of Channels in a Multi-Channel Communication System,” which is commonly assigned herewith and incorporated by reference herein. Such modes of operation may include, for example, a joining mode and a tracking mode. However, this type of multiple mode operation is not a requirement of the present invention.

Illustrative embodiments of the invention will be described herein with reference to DMT tones. However, the term “tone” as used herein is intended to be broadly construed so as to encompass not only DMT tones but also other types of sub-carriers of other multi-carrier communication systems.

It is assumed for illustrative purposes only that downstream transmission over each of the N channels 106 in the system 100 is implemented using DMT modulation with M tones per channel. The nature of the channel from one transmitter to one receiver on a particular tone can be described by a complex coefficient.

The crosstalk from a disturber line into a victim line can be represented by a single complex vector which has as many components as there are DMT tones. For example, a given implementation of the system 100 may utilize 4096 DMT tones, in which case the complex vector would include 4096 components, one for each tone. Each component may be viewed as comprising a coefficient, also referred to herein as a crosstalk channel coefficient. It should be understood, however, that the set of DMT tones is typically separated into upstream and downstream tones, and some tones may not be subject to crosstalk control. Thus, the dimensionality of the complex vector of crosstalk channel coefficients is typically smaller than the total number of tones.

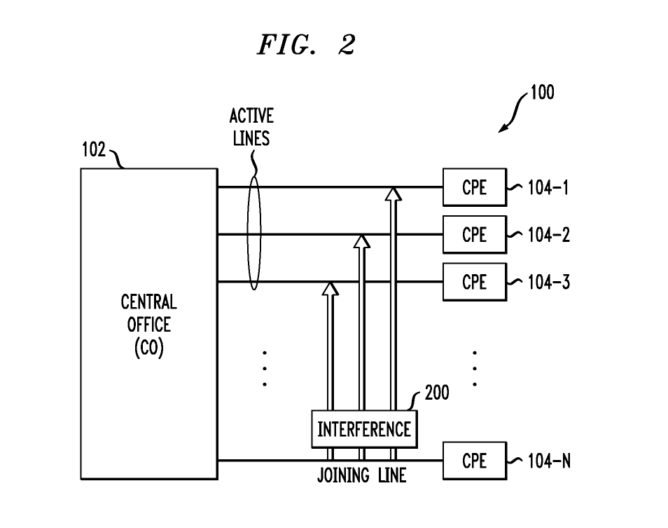

FIG. 2 illustrates an example of a joining arrangement involving the N lines 106 previously described in conjunction with FIG. 1. In this example, lines 1, N−1 collectively form a group of active lines and line N is a new joining line. It is assumed that the CO 102 has already obtained estimates of the crosstalk channel coefficients between the active lines and is utilizing post-compensation based on these estimates to suppress the interference between the active lines for upstream communications. It is desired to obtain estimates of the crosstalk channel coefficients between the joining line and each of the active lines so that the CO 102 can utilize post-compensation based on these estimates to significantly reduce interference 200 between the joining line and the active lines.

Referring now to FIG. 3, the manner in which post-compensation is implemented in the system 100 in one embodiment is shown. The post-compensation is illustrated for crosstalk from a joining line 106_{J} into a given active line 106_{A}, although it is assumed that post-compensation is also implemented in a similar manner to control crosstalk from the joining line into each of the other active lines. Also, a given joining line may at other times be an active line, and vice-versa, such that the same general crosstalk control configuration may be provided for all of the lines 106 of system 100.

The CPE 104_{J} and 104_{A} associated with the respective joining and active lines 106_{J} and 106_{A} comprise, among other elements not explicitly shown, respective channel encoders 300_{J} and 300_{A}. These channel encoders may be implemented in respective CPE transmitters. The CO 102 includes for the lines 106_{J} and 106_{A} respective channel detectors 302_{J} and 302_{A} and respective buffers 304_{J} and 304_{A}. The channel detectors may be viewed as respective examples of what are more generally referred to herein as “receivers.” The CO 102 further includes a crosstalk estimator 310 and a crosstalk canceller 312, which may be viewed as illustrative examples of the respective crosstalk estimation module 110 and crosstalk control module 112 of FIG. 1. The buffers 304_{J} and 304_{A} are coupled between outputs of the respective channel detectors 302_{J} and 302_{A} and corresponding inputs of the crosstalk canceller 312. Outputs of the channel detectors 302_{J} and 302_{A} are also coupled to corresponding inputs of crosstalk estimator 310.

In the FIG. 3 arrangement, x denotes an initialization signal vector transmitted using a given tone of the joining line 106_{J} by the corresponding CPE 104_{J} and also known to the CO 102, a denotes a signal vector transmitted using the given tone of the active line 106_{A} by the corresponding CPE 104_{A} to the CO 102, g denotes a crosstalk coefficient characterizing crosstalk from the joining line into the active line for the given tone, y denotes a received signal vector at an output of the channel detector 302_{A}, and ĝ denotes an estimate of the crosstalk coefficient characterizing the crosstalk from the joining line into the active line for the given tone. The crosstalk estimator 310 generates the crosstalk estimate ĝ using the initialization signal vector x known to the CO, and the received signal vector y. The crosstalk canceller 312 utilizes the crosstalk coefficient estimate k to generate post-compensated vectors \hat{x} and â.

The given tone of each of the joining and active lines as noted above may be referenced by a tone index t, where 1≦t≦M. However, the tone index t will generally be suppressed in the present description in order to simplify the notation.

It is assumed in the present embodiment that the initialization signal vector x is known to the CO 102, and is therefore utilized by the crosstalk estimator 310 to generate the crosstalk estimate k. If this information is not available in the CO, the received version of the initialization signal vector x transmitted by the joining line CPE 104_{J} may be used instead in determining the crosstalk coefficients. Therefore, references to initialization signal vector x in the context of generating crosstalk estimates in crosstalk estimator 310 may refer to either the vector x known a priori to the CO or the vector x as received in the CO from the joining line CPE.

The channel detectors 302_{J} and 302_{A} process the respective incoming signals from lines 106_{J} and 106_{A}. This processing includes performing a Fast Fourier Transform (FFT) using conventional techniques. The resulting outputs are fed to the crosstalk estimator 310. At the same time, the detector outputs are buffered in respective buffers 304_{J} and 304_{A}. The buffers are configured to introduce a short delay, generally on the order of a few DMT symbols up to about a few hundred DMT symbols. This type of delay arrangement allows the crosstalk estimator to quickly obtain an initial estimate of the crosstalk coefficient that can be utilized by the crosstalk canceller for post-compensation of the received signals of the joining and active lines. More accurate estimates can then be gradually obtained over time. It is important to choose the delay such that the initial effect of crosstalk from the joining line into the active line is reduced sufficiently by post-compensation. The particular amount of buffering needed to provide the desired delay in a given embodiment will depend on implementation-specific factors such as signal data rates. Note that the data for both the joining line and the active line are buffered in this embodiment.

As a more particular example of an amount of buffering suitable for use in a given embodiment of the invention, assume that the active line is using 10 bits per tone on all tones. If sync symbols are not available for use in the crosstalk estimation process, the buffers may each have a size given by approximately 200 DMT symbols, thereby providing a delay of approximately 50 milliseconds. Although such an amount of delay is practical, a smaller delay is typically desirable and may alternatively be used. Also, if sync symbols are available for use in the crosstalk estimation process, each buffer may then have a smaller size, such as one given by approximately 100 DMT symbols. Of course, other amounts of buffering may be used in other embodiments of the invention.

The operation of the post-compensation arrangement of FIG. 3 will now be described in greater detail. As noted above, the tone index t will be suppressed in order to simplify the notation.

The CPE 104_{J} of the joining line 106_{J} sends at the given tone the initialization signal vector x=x₁ x₂ . . . xₙ in n consecutive DMT symbols and the CPE 104_{A} of the active line 106_{A} sends at the same tone the signal vector a=a₁ a₂ . . . aₙ. It is important to appreciate that the initialization signal x=x₁ x₂ . . . xₙ is usually defined by a standard and therefore it is known to the CO 102 in advance. See, for example, the VDSL2 standard, described in ITU-T Recommendation G.993.2, “Very high speed digital subscriber line transceivers 2,” February, 2006, which is incorporated by reference herein. According to such standards the value n is usually at least 512.

Let y=y₁ y₂ . . . yₙ be the received signal vector, where component yⱼ, 1≦j≦n, is given by

yⱼ=aⱼ+gxⱼ+zⱼ, (1)

where g is the crosstalk coefficient of the joining line 106_{J} into the active line 106_{A}, and zⱼ denotes the noise. For now, we assume that the noise vector z=z₁ z₂ . . . zₙ is a complex Gaussian vector. Note that in the absence of any crosstalk cancellation, the additional interference from the second term in (1) lowers the signal-to-noise ratio (SNR) on the tone. When a line joins, the crosstalk may reduce the SNR for a significant number of upstream tones of the active line, and this may then cause the active line to be dropped. By introducing the buffers 304_{J} and 304_{A}, the crosstalk estimator 310 will be given some time to correlate the received signal y with the initialization signal vector x. That is, we compute

x^{†}y=x^{†}a+g∥x∥²+x^{†}z, (2)

where ^{†} denotes the transpose operator. The estimator

ĝ=(x^{†}y)/∥x∥² (3)

is unbiased for g, since the vectors x, a, and z are mutually independent and have zero mean. To a good approximation, the distribution of the error can be taken to be Gaussian. The variance of the estimate is

Var(ĝ)=(Var(a)+Var(z))∥x∥²,

where Var(a) and Var(z) are the variances of individual components of vectors a and z respectively. Note that, to keep notation short, we assume that all components of a have the same variance Var(a) and all components of z have the same variance Var(z), although it is to be appreciated that this assumption and other assumptions made herein are not requirements of the invention. The precision of the estimate is

\hat{P}=1/Var(g)=∥x∥²/(Var(a)+Var(z))

From this equation one can see that the larger the value of n the higher the precision of the estimate.

If during transmission of the initialization vector x the active line transmits m sync symbols, the crosstalk estimator 310 in CO 102 can obtain a better estimate of g in the following manner. Assume that at instances j₁ . . . jₘ sync symbols are transmitted. Since sync symbols are generally defined by a standard, such as the above-noted VDSL2 standard, the values aⱼ_{₁}, . . . , aⱼ_{ₘ} are known to the CO in advance. Denote

a_{sync}=(aⱼ_{₁}, . . . , aⱼ_{ₘ})

and similarly

x_{sync}=(xⱼ_{₁}, . . . ,xⱼ_{ₘ}),z_{sync}=(zⱼ_{₁}, . . . ,zⱼ_{ₘ}),y_{sync}=(yⱼ_{₁}, . . . ,yⱼ_{ₘ})

The CO can then estimate g as follows:

ĝ_{sync}=(y_{sync}−a_{sync})/∥x_{sync}∥².

The precision of this estimate is

\hat{P}_{sync}=∥x_{sync}∥²/Var(z)

Finally, the CO 102 can combine these two estimates ĝ and ĝ_{sync} to obtain a further improved estimate ĝ_{c} as follows:

ĝ_{c}=(\hat{P}ĝ+\hat{P}_{sync}ĝ_{sync})/\hat{P}+\hat{P}_{sync}).

This is just one possible example illustrating the generation of an estimated crosstalk coefficient as a combination of at least first and second different estimates of the coefficient, in which the first and second different estimates are weighted with their respective estimated precisions. Alternative arrangements could use other techniques to combine the estimates, other types of weights, etc.

It is to be appreciated that the above-described crosstalk estimation techniques are presented by way of illustrative example only, and that any number of other crosstalk estimation algorithms may be utilized in the crosstalk estimator 310 to obtain the crosstalk estimates. In general, the more powerful the crosstalk estimator, the faster the estimates can be obtained and the shorter the required buffers. For example, the CO 102 can store in memory previous estimates of g. Such stored previous estimates are often referred to as being retained in a crosstalk database. With time the value of g is changing, but only slowly and in most cases in a systematic way. Hence, by combining previous estimates of g with new ones, the CO can further improve the estimate precision. Another possibility is to use correlation between values of g^{(t)} in different tones. For example, one can use the denoising algorithm described in the above-cited U.S. patent application Ser. No. 12/352,896.

The illustrative arrangement shown in FIG. 3 advantageously allows the crosstalk estimator 310 to quickly determine initial estimates of the crosstalk coefficients such that the crosstalk canceller 312 can use the initial estimates to at least partially cancel the effects of crosstalk. This allows lines to join without significantly increasing the risk of line dropping, while retaining the advantages of post-compensation.

Although the FIG. 3 arrangement is particularly beneficial in situations that involve joining one or more lines to a group of active lines, it can also be applied in other situations, such as situations where there is a sudden change in one or more lines, e.g., a disorderly leaving event. Thus, the disclosed techniques provide a general mechanism for mitigating the crosstalk effects of sudden line changes.

Illustrative embodiments of the invention therefore significantly increase the robustness of the upstream in DSL systems. Sudden variations in the upstream lines can be detected and action can be taken to produce new crosstalk estimates that can be used to suppress the effects of crosstalk. Conventional systems fail to provide a delayed post-compensation arrangement, and in such systems the continued application of post-compensation in the presence of sudden line changes can actually make performance at such times worse than it would be without any post-compensation at all.

As indicated previously, embodiments of the present invention may be implemented at least in part in the form of one or more software programs that are stored in memory 120 or other computer-readable medium of CO 102. Such programs may be retrieved and executed by processor 115 in CO 102. The crosstalk estimator 310 and crosstalk canceller 312 may be implemented at least in part using software programs. Of course, numerous alternative arrangements of hardware, software or firmware in any combination may be utilized in implementing these and other systems elements in accordance with the invention. For example, embodiments of the present invention may be implemented in a DSL chip or other similar integrated circuit device.

It should again be emphasized that the embodiments described above are for purposes of illustration only, and should not be interpreted as limiting in any way. Other embodiments may use different communication system configurations, CO and CPE configurations, communication channels, and crosstalk estimation and crosstalk control techniques, depending on the needs of the particular communication application. Alternative embodiments may therefore utilize the techniques described herein in other contexts in which it is desirable to implement effective crosstalk control in the presence of joining lines or other sudden upstream channel changes.

By way of example, pilot tones may be provided in both upstream and downstream directions and used to assist the acquisition of crosstalk coefficients for legacy lines, although at the penalty of some rate loss in the active lines.

It should also be noted that the particular assumptions made in the context of describing the illustrative embodiments should not be construed as requirements of the invention. The invention can be implemented in other embodiments in which these particular assumptions do not apply.

These and numerous other alternative embodiments within the scope of the appended claims will be readily apparent to those skilled in the art.

What is claimed is:

1. An apparatus for controlling crosstalk between channels of a multi-channel communication system, the apparatus comprising:
first and second receivers for receiving signals over respective first and second channels of the system;
a crosstalk estimation module having inputs coupled to respective outputs of the first and second receivers, the crosstalk estimation module processing the signal received over the second channel and an initialization signal associated with the first channel to obtain estimated crosstalk coefficients characterizing crosstalk from the first channel into the second channel;
first and second buffers having inputs coupled to the respective outputs of the first and second receivers and being configured to introduce respective predetermined delays into the respective signals received over the first and second channels; and
a crosstalk control module having inputs coupled to respective outputs of the first and second buffers and an additional input adapted to receive the estimated crosstalk coefficients from the crosstalk estimation module, the crosstalk control module utilizing the estimated crosstalk coefficients to adjust the signal received over the second channel as delayed by the second buffer in order to compensate for the crosstalk from the first channel into the second channel.

2. The apparatus of claim 1 wherein the initialization signal associated with the first channel is available to the crosstalk estimation module independently of the signal received over the first channel.

3. The apparatus of claim 1 wherein the initialization signal associated with the first channel is the signal received over the first channel.

4. The apparatus of claim 1 wherein the first channel is a joining channel and the second channel is an active channel.

5. The apparatus of claim 1 wherein the apparatus is implemented in an access node of the system.

6. The apparatus of claim 1 wherein the first and second channels comprise respective first and second subscriber lines of a DSL system with each such subscriber line comprising a plurality of tones.

7. The apparatus of claim 6 wherein the crosstalk estimation module generates at least one of the estimated crosstalk coefficients as:
ĝ=(x^{†}y)/∥x∥²
where x=x₁ x₂ . . . xₙ denotes the initialization signal for a given tone of the first subscriber line, y=y₁ y₂ . . . yₙ denotes the signal received for the given tone of the second subscriber line, and n denotes a number of consecutive symbols used to transmit the signals.

8. The apparatus of claim 6 wherein the crosstalk estimation module generates at least one of the estimated crosstalk coefficients as:
ĝ=(y_{sync}−a_{sync})/∥x_{sync}∥²,
where
y_{sync}=(yⱼ_{₁}, . . . ,yⱼ_{ₘ}),a_{sync}=(aⱼ_{₁}, . . . ,aⱼ_{ₘ}),x_{sync}=(xⱼ_{₁}, . . . , xⱼ_{ₘ}),
and where a_{sync}=(aⱼ_{₁}, . . . , aⱼ_{ₘ}) denotes m synchronization symbols transmitted at respective instances j₁, . . . , jₘ for a given tone of the second subscriber line, y_{sync}=(yⱼ_{₁}, . . . , yⱼ_{ₘ}) denotes the signal received for the given tone of second subscriber line for the m instances, and x_{sync}=(xⱼ_{₁}, . . . , xⱼ_{ₘ}) denotes the initialization signal for the given tone of the first subscriber line for the m instances.

9. The apparatus of claim 1 wherein the crosstalk estimation module generates at least one of the estimated crosstalk coefficients as a combination of at least first and second different estimates of the coefficient, in which the first and second different estimates are weighted with their respective estimated precisions.

10. The apparatus of claim 9 wherein the estimated crosstalk coefficient is generated as a combination of two estimates ĝ and ĝ_{sync} and is given by:
ĝ_{c}=(\hat{P}ĝ+\hat{P}_{sync}ĝ_{sync})/\hat{P}+\hat{P}_{sync}).
where \hat{P} denotes the precision of ĝ and \hat{P}_{sync} denotes the precision of ĝ_{sync}.

11. A method of controlling crosstalk between channels of a multi-channel communication system, the method comprising the steps of:
receiving signals over respective first and second channels of the system;
processing the signal received over the second channel and an initialization signal associated with the first channel to obtain estimated crosstalk coefficients characterizing crosstalk from the first channel into the second channel;
introducing respective predetermined delays into the respective signals received over the first and second channels; and
utilizing the estimated crosstalk coefficients to adjust the signal received over the second channel as delayed by the corresponding predetermined delay in order to compensate for the crosstalk from the first channel into the second channel.

12. The method of claim 11 wherein the first and second channels comprise respective first and second subscriber lines of a DSL system with each such subscriber line comprising a plurality of tones.

13. The method of claim 12 wherein the processing step further comprises generating at least one of the estimated crosstalk coefficients as:
ĝ=(x^{†}y)/∥x∥²
where x=x₁ x₂ . . . xₙ denotes the initialization signal for a given tone of the first subscriber line, y=y₁ y₂ . . . yₙ denotes the signal received for the given tone of the second subscriber line, and n denotes a number of consecutive symbols used to transmit the signals.

14. The method of claim 12 wherein the processing step further comprises generating at least one of the estimated crosstalk coefficients as:
ĝ=(y_{sync}−a_{sync})/∥x_{sync}∥²,
where
y_{sync}=(yⱼ_{₁}, . . . ,yⱼ_{ₘ}),a_{sync}=(aⱼ_{₁}, . . . ,aⱼ_{ₘ}),x_{sync}=(xⱼ_{₁}, . . . , xⱼ_{ₘ}),
and where a_{sync}=(aⱼ_{₁}, . . . , aⱼ_{ₘ}) denotes m synchronization symbols transmitted at respective instances j₁, . . . , jₘ for a given tone of the second subscriber line, y_{sync}=(yⱼ_{₁}, . . . , yⱼ_{ₘ}) denotes the signal received for the given tone of second subscriber line for the m instances, and x_{sync}=(xⱼ_{₁}, . . . , xⱼ_{ₘ}) denotes the initialization signal for the given tone of the first subscriber line for the m instances.

15. The method of claim 11 wherein the processing step further comprises generating at least one of the estimated crosstalk coefficients as a combination of at least first and second different estimates of the coefficient, in which the first and second different estimates are weighted with their respective estimated precisions.

16. The method of claim 15 wherein the estimated crosstalk coefficient is generated as a combination of two estimates ĝ and ĝ_{sync} and is given by:
ĝ_{c}=(\hat{P}ĝ+\hat{P}_{sync}ĝ_{sync})/\hat{P}+\hat{P}_{sync}).
where \hat{P} denotes the precision of ĝ and \hat{P}_{sync} denotes the precision of ĝ_{sync}.

17. A computer-readable storage medium having embodied therein executable program code that when executed by a processor of an access node of the system causes the access node to perform the steps of the method of claim 11.

18. A communication system comprising:
an access node; and
a plurality of terminal units;
wherein the access node is configured to communicate with the terminal units over respective channels of the system;
wherein the access node comprises:
first and second receivers for receiving signals over respective first and second ones of the channels of the system;
a crosstalk estimation module having inputs coupled to respective outputs of the first and second receivers, the crosstalk estimation module processing the signal received over the second channel and an initialization signal associated with the first channel to obtain estimated crosstalk coefficients characterizing crosstalk from the first channel into the second channel;
first and second buffers having inputs coupled to the respective outputs of the first and second receivers and being configured to introduce respective predetermined delays into the respective signals received over the first and second channels; and
a crosstalk control module having inputs coupled to respective outputs of the first and second buffers and an additional input adapted to receive the estimated crosstalk coefficients from the crosstalk estimation module, the crosstalk control module utilizing the estimated crosstalk coefficients to adjust the signal received over the second channel as delayed by the second buffer in order to compensate for the crosstalk from the first channel into the second channel.

19. The system of claim 18 wherein the access node is implemented in a central office of a DSL system.

20. The system of claim 18 wherein the crosstalk control module comprises a crosstalk canceller.
